(19) United States
(12) Patent Application Publication
(10) Pub. No.: US 2023/0274674 A1
(43) Pub. Date: Aug. 31, 2023

(54) CONTROL METHOD FOR PROJECTOR AND PROJECTOR

(71) Applicant: SEIKO EPSON CORPORATION, Tokyo (JP)

(72) Inventors: Masataka MIYAMOTO, Matsumoto-shi (JP); Kazuhiko TAKAGI, Matsumoto-shi (JP)

(21) Appl. No.: 18/173,842

(22) Filed: Feb. 24, 2023

(30) Foreign Application Priority Data
Feb. 25, 2022 (JP) 2022-027598

(51) Int. Cl. G09G 3/00; G09G 3/36

(52) U.S. Cl. CPC G09G 3/002; G09G 3/36; G09G 2340/0492; G09G 2340/0464; G09G 2360/18

(57) ABSTRACT

A control method for a projector includes setting, on an inside of a projectable range of a projector, a first region where a first image is displayed, the first region being a rectangular region smaller than the projectable range and, when receiving a first instruction to horizontally reverse the first image within the first region, arranging, in the first region, a first reversed image obtained by horizontally reversing the first image.

The present application is based on, and claims priority from JP Application Serial Number 2022-027598, filed Feb. 25, 2022, the disclosure of which is hereby incorporated by reference herein in its entirety.

### BACKGROUND

### 1. Technical Field

The present disclosure relates to a control method for a projector and the projector.

### 2. Related Art

JP-A-2016-114767 (Patent Literature 1) describes a projector that detects an obstacle on a display surface and, when determining that the obstacle cannot be neglected, carries out reduction, division, or shift of an image and projects the image onto a region where the obstacle is absent.

Since a projector has a wide projectable range, the projector is sometimes used to reduce an image and move a display position of the image within the projectable range in order to avoid an obstacle or the like on a display surface or facilitate visual recognition of the image by a user who views the image from a position close from the display surface.

In such a case, when a user who desires to horizontally or vertically reverse an image and view the image as if the image is reflected on a mirror executes a screen reversing function, the projector of the related art such as Patent Literature 1 has the following problem. When the screen reversing function is executed, the entire projectable range is horizontally or vertically reversed, whereby a position where the image is arranged in the projectable range changes. Therefore, it is necessary to reset a position where the image is displayed.

### SUMMARY

A control method for a projector according to an aspect of the present disclosure includes: setting, on an inside of a projectable range of a projector, a first region where a first image is displayed, the first region being a rectangular region smaller than the projectable range; and, when receiving a first instruction to horizontally reverse the first image within the first region, arranging, in the first region, a first reversed image obtained by horizontally reversing the first image.

A projector according to another aspect of the present disclosure includes a controller, the controller executing: setting, on an inside of a projectable range of the projector, a first region where a first image is displayed, the first region being a rectangular region smaller than the projectable range; and, when receiving a first instruction to horizontally reverse the first image within the first region, arranging, in the first region, a first reversed image obtained by horizontally reversing the first image.

### BRIEF DESCRIPTION OF THE DRAWINGS

FIG. 1 is a diagram showing an example of a configuration of a projector according to an embodiment.

FIG. 2 is a diagram showing an example of a configuration of a controller of the projector.

FIG. 3 is a first image transition diagram showing an example of changes of images in first processing.

FIG. 4 is a second image transition diagram showing an example of changes of images in second processing.

FIG. 5 is a flowchart showing an example of the first processing and the second processing of the controller.

FIG. 6 is a flowchart showing an example of third processing and fourth processing of the controller.

### DESCRIPTION OF EXEMPLARY EMBODIMENTS

An embodiment is explained below with reference to the drawings.

### 1. Configuration of a Projector

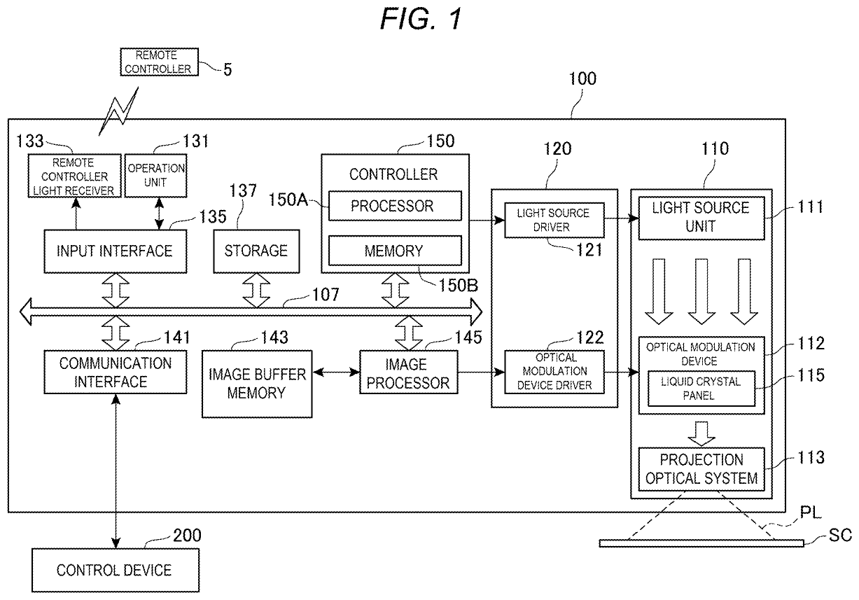

FIG. 1 is a diagram showing an example of a configuration of a projector 100 according to this embodiment.

The projector 100 projects a first image PC1 onto a first region RA1 of a screen SC. For example, the projector 100 projects projection light PLA toward the screen SC to thereby display the first image PC1 in the first region RA1 of the screen SC.

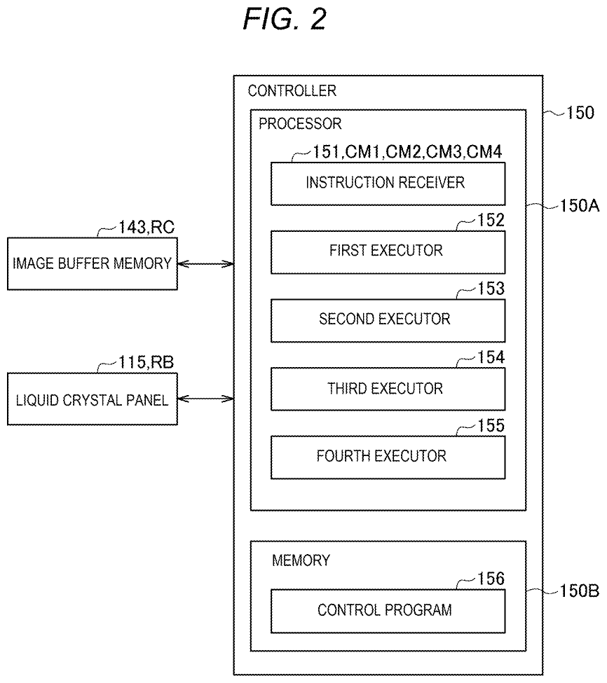

The first image PC1 and the first region RA1 are further explained with reference to FIGS. 2 to 5.

In this embodiment, for example, floor installation in which the projector 100 is placed on a floor in front of the screen SC is explained. However, for example, the projector 100 may be suspended from a ceiling and installed. In this embodiment, projection onto a flat screen SC by the projector 100 is illustrated. However, a projection target is not limited to the screen SC and may be a plane such as a wall surface of a building or may be a curved surface or an uneven surface.

As shown in FIG. 1, the projector 100 includes a projecting unit 110 and a driver 120 that drives the projecting unit 110. The projecting unit 110 forms an optical image and projects the image onto the screen SC.

The projecting unit 110 includes a light source unit 111, an optical modulation device 112, and a projection optical system 113. The driver 120 includes a light source driver 121 and an optical modulation device driver 122.

The light source unit 111 includes a lamp such as a halogen lamp, a xenon lamp, or an ultrahigh pressure mercury lamp or a solid-state light source such as an LED (Light Emitting Diode) or a laser light source.

The light source unit 111 may include a reflector that guides light emitted by the light source to the optical modulation device 112 and an auxiliary reflector. Further, the light source unit 111 may include a lens group and a polarizing plate for improving optical characteristics of projection light or a dimming element that reduces, on a path leading to the optical modulation device 112, a light amount of the light emitted by the light source.

The light source driver 121 is connected to an internal bus 107 and lights and extinguishes the light source of the light source unit 111 according to an instruction of a controller 150 connected to the internal bus 107.

The optical modulation device 112 includes, for example, three liquid crystal panels 115 corresponding to the three primary colors of R, G, and B. R indicates red, G indicates green, and B indicates blue. That is, the optical modulation device 112 includes the liquid crystal panel 115 corresponding to R color light, the liquid crystal panel 115 corresponding to G color light, and the liquid crystal panel 115 corresponding to B color light.

Light emitted by the light source unit 111 is separated into color lights of the three colors of RGB. The color lights are respectively made incident on the liquid crystal panels 115 corresponding to the color lights. Each of the three liquid crystal panels 115 is a transmissive liquid crystal panel and modulates transmitted light to generate image light PL. Image lights PL transmitted through and modulated by the liquid crystal panels 115 are combined by a combination optical system such as a cross dichroic prism and emitted to the projection optical system 113.

The optical modulation device 112 is driven by the optical modulation device driver 122. The optical modulation device driver 122 is connected to an image processor 145.

Image data corresponding to the primary colors of R, G, and B are input to the optical modulation device driver 122 from the image processor 145. The optical modulation device driver 122 converts the input image data into data signals suitable for the operations of the liquid crystal panels 115. The optical modulation device driver 122 applies voltages to pixels of the liquid crystal panels 115 based on the converted data signals and draws images on the liquid crystal panels 115.

The projection optical system 113 includes a lens and a mirror that focus, on the screen SC, the image lights PL made incident on the projection optical system 113. The projection optical system 113 may include a zoom mechanism that enlarges or reduces an image projected onto the screen SC and a focus adjusting mechanism that performs adjustment of a focus.

The projector 100 further includes an operation unit 131, a remote controller light receiver 133, an input interface 135, a storage 137, a communication interface 141, an image buffer memory 143, an image processor 145, and a controller 150. The input interface 135, the storage 137, the communication interface 141, the image processor 145, and the controller 150 are connected to one another via the internal bus 107 to be capable of performing data communication.

The operation unit 131 includes various buttons and switches provided on a housing surface of the projector 100, generates operation signals corresponding to operation of the buttons and the switches, and outputs the operation signals to the input interface 135. The input interface 135 outputs the operation signals input from the operation unit 131 to the controller 150.

The remote controller light receiver 133 receives an infrared signal transmitted from a remote controller 5, decodes the received infrared signal, and generates an operation signal. The remote controller light receiver 133 outputs the generated operation signal to the input interface 135. The input interface 135 outputs the operation signal input from the remote controller light receiver 133 to the controller 150.

The storage 137 is a nonvolatile storage device such as a HDD (Hard Disk Drive) or an SSD (Solid State Drive). The storage 137 stores programs to be executed by the controller 150, data and image data processed by the controller 150, and the like.

The communication interface 141 includes a connector and an interface circuit and is communicably connected to a control device 200. In this embodiment, the communication interface 141 is an interface for communicating with the control device 200 according to, for example, the Ethernet (registered trademark) standard.

The controller 150 includes a processor 150A and a memory 150B.

The memory 150B is a storage device that stores, in a nonvolatile manner, programs to be executed by the processor 150A and data. The memory 150B is configured by a magnetic storage device, a semiconductor storage element such as a flash ROM (Read Only Memory), or a nonvolatile storage device of another type. The memory 150B may include a RAM (Random Access Memory) configuring a work area of the processor 150A. The memory 150B may include a nonvolatile storage device such as a HDD or an SSD.

The memory 150B stores data to be processed by the controller 150 and a control program 156 to be executed by the processor 150A.

The processor 150A may be configured by a single processor. A plurality of processors may function as the processor 150A. The processor 150A executes the control program 156 and controls the units of the projector 100. For example, the processor 150A outputs, to the image processor 145, an execution instruction for image processing corresponding to operation received by the operation unit 131 or the remote controller 5 and parameters used for the image processing. The parameters include, for example, geometric correction parameters for correcting geometric distortion of an image to be projected onto the screen SC. The processor 150A controls the light source driver 121 and controls lighting and extinction of the light source unit 111.

Each of the image processor 145 and the controller 150 can be configured by, for example, an integrated circuit.

The integrated circuit includes an LSI, an ASIC (Application Specific Integrated Circuit), and a PLD (Programmable Logic Device). The PLD includes, for example, an FPGA (Field-Programmable Gate Array). An analog circuit may be included in a part of a configuration of the integrated circuit. A processor and the integrated circuit may be combined. The combination of the processor and the integrated circuit is called microcontroller (MCU), SoC (System-on-a-chip), system LSI, chip set, or the like.

The image processor 145 loads, in the image buffer memory 143, image data stored in the memory 150B or the storage 137. The image buffer memory 143 includes a plurality of banks. The banks have a storage capacity enough for writing image data for one frame. The image buffer memory 143 is configured by, for example, an SDRAM (Synchronous Dynamic Random Access Memory).

The image processor 145 performs, according to an instruction from the controller 150, on the image data loaded in the image buffer memory 143, image processing such as resolution conversion processing, resize processing, correction of distortion aberration, shape correction processing, digital zoom processing, and adjustment of a tint and luminance of an image.

### 2. Configuration of the Controller

FIG. 2 is a diagram showing an example of a configuration of the controller 150 of the projector 100.

As shown in FIG. 2, the controller 150 includes an instruction receiver 151, a first executor 152, a second executor 153, a third executor 154, and a fourth executor 155. Specifically, the processor 150A of the controller 150 executes the control program 156 stored in the memory 150B to thereby function as the instruction receiver 151, the first executor 152, the second executor 153, the third executor 154, and the fourth executor 155.

The instruction receiver 151 receives a first instruction CM1, a second instruction CM2, a third instruction CM3, and a fourth instruction CM4 from a user according to operation of the user on the operation unit 131 or the remote controller 5. The first instruction CM1 is an instruction to horizontally reverse the first image PC1 within the first region RA1. The second instruction CM2 is an instruction to horizontally reverse the first image PC1 within a projectable range RA. The third instruction CM3 is an instruction to vertically reverse the first image PC1 within the first region RA1. The fourth instruction CM4 is an instruction to vertically reverse the first image PC1 within the projectable range RA.

In the following explanation in this embodiment, the projector 100 receives the first instruction CM1, the second instruction CM2, the third instruction CM3, and the fourth instruction CM4 from the user according to operation of the user on the operation unit 131 or the remote controller 5. However, not only this, but, for example, the control device 200 may receive the first instruction CM1, the second instruction CM2, the third instruction CM3, and the fourth instruction CM4 and transmit the received first instruction CM1 to the fourth instruction CM4 to the projector 100.

Note that, in this embodiment, before the instruction receiver 151 receives the first instruction CM1 to the fourth instruction CM4, the controller 150 sets the first region RA1, which is a rectangular region for displaying the first image PC1, on the inside of the projectable range RA of the projector 100.

The first region RA1 is smaller than the projectable range RA. The first region RA1 is set in a position where a line that horizontally symmetrically divides the first region RA1 and a line that horizontally symmetrically divides the projectable region RA do not coincide. The first region RA1 is set in a position where a line that vertically symmetrically divides the first region RA1 and a line that vertically symmetrically divides the projectable range RA do not coincide.

The projectable range RA is set in advance in a rectangular region located on the inside of a display surface of the screen SC. The projectable range RA corresponds to a displayable range of each of the liquid crystal panels 115. The displayable range of the liquid crystal panel 115 is described as displayable range RB of the liquid crystal panel 115 in the following explanation.

As explained with reference to FIG. 1, the liquid crystal panels 115 are configured by the liquid crystal panel 115 corresponding to the R color light, the liquid crystal panel 115 corresponding to the G color light, and the liquid crystal panel 115 corresponding to the B color light. For example, when a fixed pixel value equal to or larger than a predetermined value is set in all pixels configuring the liquid crystal panel 115 corresponding to the R color light and a pixel value of all pixels configuring each of the liquid crystal panel 115 corresponding to the G color light and the liquid crystal panel 115 corresponding to the B color light is set to zero, a red solid image is displayed in the projectable range RA of the screen SC. That is, the displayable range RB of the liquid crystal panel 115 corresponds to the projectable range RA.

The displayable range RB of the liquid crystal panel 115 corresponds to a storable range of the image buffer memory 143. For example, when an image stored in the entire range of the image buffer memory 143 is drawn on the liquid crystal panel 115, the image is drawn in the entire range of the liquid crystal panel 115.

Therefore, the storable range of the image buffer memory 143 is described as storable range RC in the following explanation. The storable range RC corresponds to the displayable range RB and the projectable range RA.

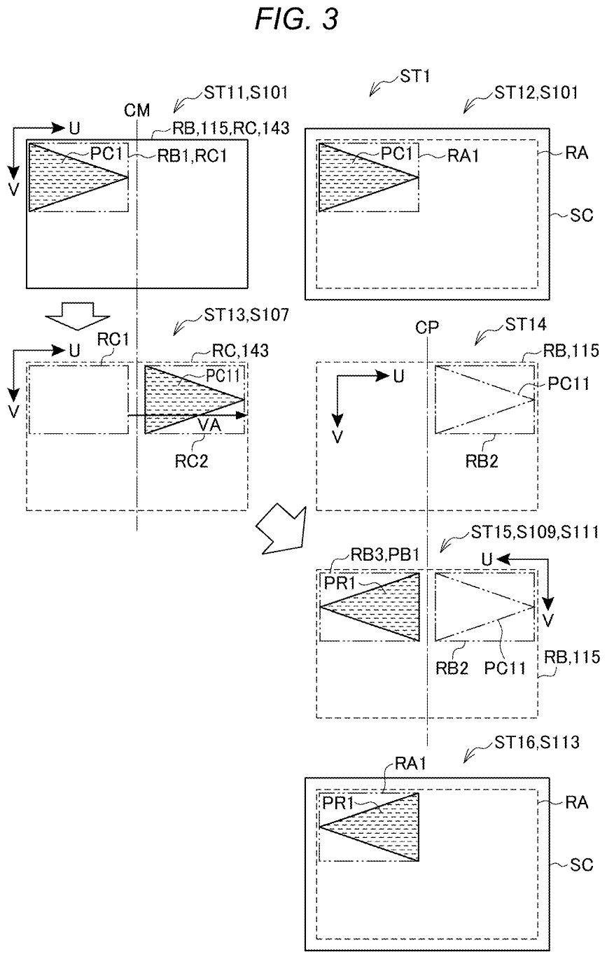

A coordinate corresponding to a panel coordinate of the liquid crystal panel 115 is set in a storage region of the image buffer memory 143. In this embodiment, as explained below with reference to FIG. 3, the panel coordinate of the liquid crystal panel 115 is defined by a U axis and a V axis. A coordinate defined by the U axis and the V axis is set in the storage region of the image buffer memory 143.

When the instruction receiver 151 receives the first instruction CM1, the first executor 152 arranges, in the first region RA1, a first reversed image PR1 obtained by horizontally reversing the first image PC1.

For example, the first executor 152 executes “first processing” to thereby arrange, in the first region RA1, the first reversed image PR1 obtained by horizontally reversing the first image PC1. The “first processing” is processing executed by the first executor 152 when the instruction receiver 151 receives the first instruction CM1.

The “first processing” includes moving a display position of the first image PC1 in the left or right direction according to geometric correction in the image buffer memory 143 and reversing the panel coordinate of the liquid crystal panel 115 in the horizontal direction.

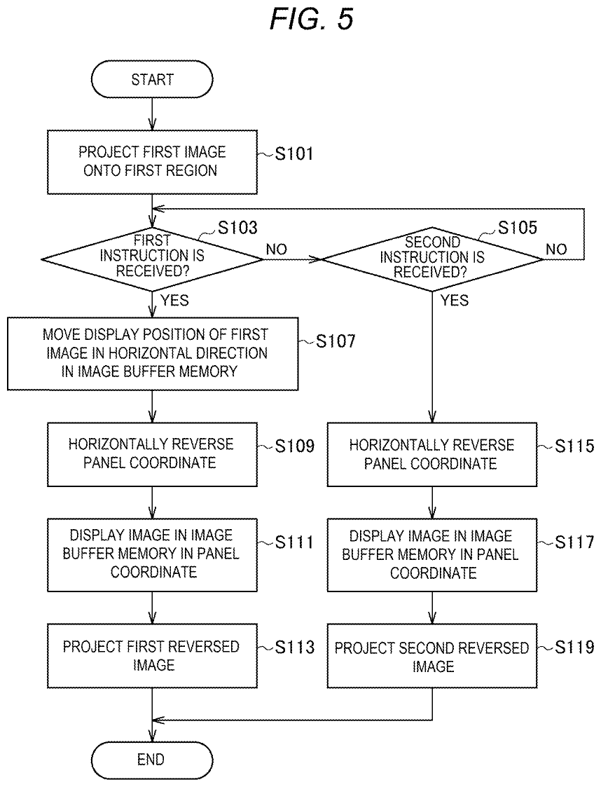

The “first processing” of the first executor 152 is further explained with reference to FIGS. 3 and 5.

When the instruction receiver 151 receives the second instruction CM2, the second executor 153 arranges a second reversed image PR2 obtained by horizontally reversing the first image PC1 within the projectable range RA.

For example, the second executor 153 executes “second processing” to thereby arrange the second reversed image PR2 obtained by horizontally reversing the first image PC1 based on the projectable range RA. The “second processing” is processing executed by the second executor 153 when the instruction receiver 151 receives the second instruction CM2.

The “second processing” includes reversing the panel coordinate of the liquid crystal panel 115 in the horizontal direction.

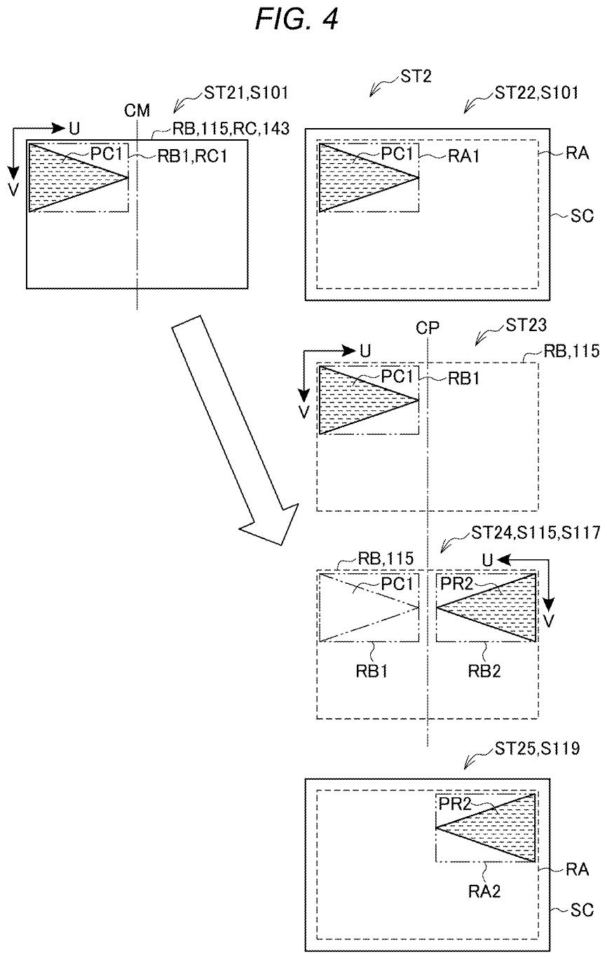

The “second processing” of the second executor 153 is further explained with reference to FIGS. 4 and 5.

When the instruction receiver 151 receives the third instruction CM3, the third executor 154 arranges, in the first region RA1, a third reversed image obtained by vertically reversing the first image PC1.

For example, the third executor 154 executes “third processing” to thereby arrange, in the first region RA1, the third reversed image obtained by vertically reversing the first image PC1. The “third processing” is processing executed by the third executor 154 when the instruction receiver 151 receives the third instruction CM3.

The “third processing” includes moving the display position of the first image PC1 in the vertical direction according to the geometric correction in the image buffer memory 143 and reversing the panel coordinate of the liquid crystal panel 115 in the vertical direction.

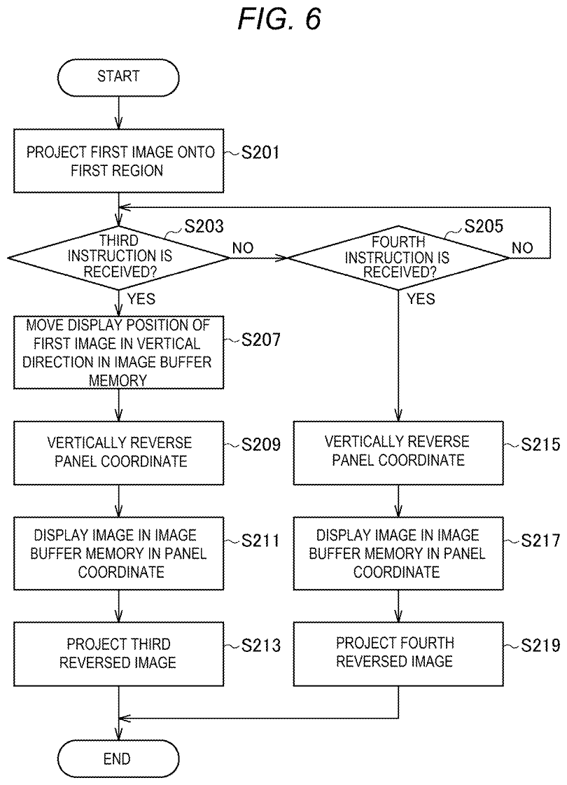

The “third processing” of the third executor 154 is further explained with reference to FIG. 6.

The “third processing” is obtained by converting “horizontal (horizontally)” in the “first processing” into “vertical (vertically)”. Therefore, in the following explanation, the “first processing” is mainly explained and the “third processing” is explained with reference to FIG. 6.

When the instruction receiver 151 receives the fourth instruction CM4, the fourth executor 155 arranges a fourth reversed image obtained by vertically reversing the first image PC1 within the projectable range RA.

For example, the fourth executor 155 executes “fourth processing” to thereby arrange the fourth reversed image obtained by vertically reversing the first image PC1 based on the projectable range RA. The “fourth processing” is processing executed by the fourth executor 155 when the instruction receiver 151 receives the fourth instruction CM4.

The “fourth processing” includes reversing the panel coordinate of the liquid crystal panel 115 in the vertical direction.

The “fourth processing” of the fourth executor 155 is further explained with reference to FIG. 6.

The “fourth processing” is obtained by converting “horizontal (horizontally)” in the “second processing” into “vertical (vertically)”. Therefore, in the following explanation, the “second processing” is mainly explained and the “fourth processing” is explained with reference to FIG. 6.

### 3. Specific Example of the First Processing

Subsequently, an example of changes of images in the first processing is explained with reference to FIG. 3. FIG. 3 is a first image transition diagram ST1 showing an example of changes of images in the first processing.

The first image transition diagram ST1 includes a first image diagram ST11, a second image diagram ST12, a third image diagram ST13, a fourth image diagram ST14, a fifth image diagram ST15, and a sixth image diagram ST16.

The first image diagram ST11 is an image diagram showing an image stored in the image buffer memory 143 and an image displayed on the liquid crystal panel 115 in an initial state. The second image diagram ST12 is an image diagram showing an image displayed on the screen SC in the initial state.

As shown in the first image diagram ST11, the U axis and the V axis are set as coordinate axes in each of the image buffer memory 143 and the liquid crystal panel 115. The U axis is an axis in the horizontal direction. A positive direction of the U axis is set in the right direction in the initial state. The V axis is an axis in the vertical direction. A positive direction of the V axis is set in the downward direction.

In the initial state, as shown in the first image diagram ST11, the controller 150 stores the first image PC1 in a first region RC1 of the image buffer memory 143. As shown in the first image diagram ST11, the controller 150 displays the first image PC1 in a first region RB1 of the liquid crystal panel 115. The first region RC1 is arranged in an upper left part in the storable range RC. The first region RB1 is arranged in an upper left part in the displayable range RB.

The first image PC1 is, for example, an isosceles triangle, the bottom side of which is arranged in the position of the left side of the first region RC1 in parallel to the V axis, that is, in the vertical direction. A vertex opposed to the bottom side of the first image PC1 is arranged in the position of the right side of the first region RC1.

The first image PC1 is, for example, an isosceles triangle, the bottom side of which is arranged in the position of the left side of the first region RB1 in parallel to the V axis, that is, in the vertical direction. A vertex opposed to the bottom side of the first image PC1 is arranged in the position of the right side of the first region RB1.

Each of the first region RC1 and the first region RB1 corresponds to the first region RA1 of the screen SC. That is, when the first image PC1 is stored in the first region RC1 of the image buffer memory 143, the controller 150 displays, in the displayable range RB of the liquid crystal panel 115, an image in the storable range RC of the image buffer memory 143. As a result, the controller 150 displays the first image PC1 in the first region RB1 of the liquid crystal panel 115.

When the first image PC1 is displayed in the first region RB1 of the liquid crystal panel 115, the controller 150 projects the displayable range RB of the liquid crystal panel 115 onto the projectable range RA of the screen SC. As a result, as shown in the second image diagram ST12, the controller 150 projects the first image PC1 onto the first region RA1 of the screen SC.

As shown in the second image diagram ST12, the first region RA1 is arranged in an upper left part in the projectable range RA of the screen SC.

The first image PC1 is, for example, an isosceles triangle, the bottom side of which is arranged in the position of the left side of the first region RA1, that is, in the vertical direction. A vertex opposed to the bottom side of the first image PC1 is arranged in the position of the right side of the first region RA1.

Subsequently, the “first processing” executed by the first executor 152 is explained with reference to the third image diagram ST13 to the sixth image diagram ST16.

For example, as shown in the third image diagram ST13, first, the first executor 152 moves the display position of the first image PC1 in the horizontal direction according to the geometric correction in the image buffer memory 143.

The first executor 152 moves, according to the geometric correction in the image buffer memory 143, for example, the display position of the first image PC1 to a position symmetrical with respect to a center line CM that horizontally symmetrically divides the image buffer memory 143. In the third image diagram ST13, the first region RC1 after the movement is described as second region RC2 and the first image PC1 after the movement is described as first image PC11 for convenience. The second region RC2 is arranged in an upper right part in the storable range RC. The bottom side of the first image PC11 is arranged in the position of the left side of the second region RC2. A vertex opposed to the bottom side of the first image PC11 is arranged in the position of the right side of the second region RC2.

A vector VA indicates a moving direction and a movement amount for the first executor 152 to move the display position of the first image PC1 from the first region RC1 to the second region RC2. As indicated by the vector VA, the moving direction is the right direction. The length of the vector VA indicates the movement amount for the first executor 152 to move the display position of the first image PC1.

The fourth image diagram ST14 is an image diagram showing an image on the liquid crystal panel 115 corresponding to the third image diagram ST13. In other words, the fourth image diagram ST14 shows an image displayed on the liquid crystal panel 115 when an image in the storable range RC including the first image PC11 shown in the third image diagram ST13 is displayed in the displayable range RB of the liquid crystal panel 115.

As shown in the fourth image diagram ST14, a second region RB2 is disposed in an upper right part in the displayable range RB. The second region RB2 corresponds to the second region RC2 of the image buffer memory 143. The bottom side of the first image PC11 is arranged in the position of the left side of the second region RB2. A vertex opposed to the bottom side of the first image PC11 is arranged in the position of the right side of the second region RB2.

The fourth image diagram ST14 is a diagram described to explain the fifth image diagram ST15. In this embodiment, an image shown in the fourth image diagram ST14 is not displayed on the liquid crystal panel 115. Therefore, in the fourth image diagram ST14, the second region RB2 and the first image PC11 are indicated by alternate long and two short dashes lines.

Subsequently, as shown in the fifth image diagram ST15, the first executor 152 reverses the panel coordinate of the liquid crystal panel 115 in the horizontal direction. The first executor 152 reverses the direction of the U axis of the liquid crystal panel 115. That is, the first executor 152 reverses the positive direction of the U axis of the liquid crystal panel 115 from the right direction to the left direction.

The first executor 152 displays, in the displayable range RB of the liquid crystal panel 115, an image in the storable range RC including the first image PC11 shown in the third image diagram ST13 to thereby arrange the first reversed image PR1 in a third region RB3. The third region RB3 is a region symmetrical to the second region RB2 with respect to a center line CP that horizontally symmetrically divides the liquid crystal panel 115. The third region RB3 coincides with the first region RB1. The first reversed image PR1 is an image obtained by reversing the first image PC1 in the horizontal direction.

As shown in the fifth image diagram ST15, when the first reversed image PR1 is displayed in the first region RB1 of the liquid crystal panel 115, the first executor 152 projects the displayable range RB of the liquid crystal panel 115 onto the projectable range RA of the screen SC. As a result, as shown in the sixth image diagram ST16, the first executor 152 projects the first reversed image PR1 onto the first region RA1 of the screen SC.

As explained with reference to FIG. 3, in the initial state, the controller 150 displays the first image PC1 in the first region RA1 of the screen SC. The first executor 152 moves the display position of the first image PC1 in the horizontal direction according to the geometric correction in the image buffer memory 143 and reverses the panel coordinate of the liquid crystal panel 115 in the horizontal direction. As a result, the first executor 152 can project the first reversed image PR1 onto the first region RA1 of the screen SC.

### 4. Specific Example of the Second Processing

Subsequently, an example of changes of images in the second processing is explained with reference to FIG. 4. FIG. 4 is a second image transition diagram ST2 showing an example of changes of images in the second processing.

The second image transition diagram ST2 includes a first image diagram ST21, a second image diagram ST22, a third image diagram ST23, a fourth image diagram ST24, and a fifth image diagram ST25.

The first image diagram ST21 is the same as the first image diagram ST11 shown in FIG. 3. The second image diagram ST22 is the same as the second image diagram ST12 shown in FIG. 3. Therefore, explanation is omitted about the first image diagram ST21 and the second image diagram ST22.

The “second processing” executed by the second executor 153 is explained with reference to the third image diagram ST23 to the fifth image diagram ST25.

The third image diagram ST23 is a diagram of reproduction of the first image diagram ST21 for convenience. The third image diagram ST23 is a diagram showing the displayable range RB at the time when the first image PC1 is displayed in the first region RB1 of the liquid crystal panel 115.

As shown in the fourth image diagram ST24, the second executor 153 reverses the panel coordinate of the liquid crystal panel 115 in the horizontal direction. The second executor 153 reverses the direction of the U axis of the liquid crystal panel 115. That is, the second executor 153 reverses the positive direction of the U axis of the liquid crystal panel 115 from the right direction to the left direction.

The second executor 153 draws, on the liquid crystal panel 115, the first image PC1 stored in the image buffer memory 143 to thereby arrange the second reversed image PR2 in the second region RB2. The second region RB2 is a region symmetrical to the first region RB1 with respect to the center line CP that horizontally symmetrically divides the liquid crystal panel 115. The second reversed image PR2 is an image obtained by reversing the first image PC1 in the horizontal direction.

As shown in the fourth image diagram ST24, when the second reversed image PR2 is displayed in the second region RB2 of the liquid crystal panel 115, the second executor 153 projects the displayable range RB of the liquid crystal panel 115 onto the projectable range RA of the screen SC. As a result, as shown in the fifth image diagram ST25, the second executor 153 projects the second reversed image PR2 onto a second region RA2 of the screen SC. That is, the second executor 153 projects, onto the screen SC, the second reversed image PR2 obtained by horizontally reversing the first image PC1 within the projectable range RA.

As explained with reference to FIG. 4, in the initial state, the controller 150 displays the first image PC1 in the first region RA1 of the screen SC. The second executor 153 reverses the panel coordinate of the liquid crystal panel 115 in the horizontal direction. As a result, the second executor 153 can project the second reversed image PR2 onto the second region RA2 of the screen SC. That is, the second executor 153 can project, onto the screen SC, the second reversed image PR2 obtained by horizontally reversing the first image PC1 within the projectable range RA.

### 5. First Processing and Second Processing of the Controller

Subsequently, an example of the first processing and the second processing of the controller 150 is explained with reference to FIG. 5. FIG. 5 is a flowchart showing an example of the first processing and the second processing of the controller 150.

As shown in FIG. 5, in step S101, the controller 150 projects the first image PC1 onto the first region RA1. In step S101, the controller 150 executes, for example, the processing explained with reference to the first image diagram ST11 and the second image diagram ST12 shown in FIG. 3.

Subsequently, in step S103, the instruction receiver 151 determines whether the first instruction CM1 has been received from the user.

When the instruction receiver 151 determines that the first instruction CM1 has been received (YES in step S103), the processing proceeds to step S107. The first executor 152 executes the “first processing” in steps S107 to S113. When the instruction receiver 151 determines that the first instruction CM1 has not been received (NO in step S103), the processing proceeds to step S105.

In step S105, the instruction receiver 151 determines whether the second instruction CM2 has been received from the user.

When the instruction receiver 151 determines that the second instruction CM2 has been received (YES in step S105), the processing proceeds to step S115. The second executor 153 executes the “second processing” in steps S115 to S119. When the instruction receiver 151 determines that the second instruction CM2 has not been received (NO in step S105), the processing returns to step S103.

When the instruction receiver 151 determines in step S103 that the first instruction CM1 has been received (YES in step S103), in step S107, the first executor 152 moves the display position of the first image PC1 in the horizontal direction according to the geometric correction in the image buffer memory 143. The first executor 152 moves, according to the geometric correction in the image buffer memory 143, for example, the display position of the first image PC1 to a position symmetrical with respect to the center line CM that horizontally symmetrically divides the image buffer memory 143. In step S107, the first executor 152 executes, for example, the processing explained with reference to the third image diagram ST13 shown in FIG. 3.

Subsequently, in step S109, the first executor 152 reverses the panel coordinate of the liquid crystal panel 115 in the horizontal direction. The first executor 152 reverses the direction of the U axis of the liquid crystal panel 115. That is, the first executor 152 reverses the positive direction of the U axis of the liquid crystal panel 115 from the right direction to the left direction.

Subsequently, in step S111, the first executor 152 displays, in the displayable range RB of the liquid crystal panel 115, the image in the storable range RC of the image buffer memory 143. As a result, the first executor 152 arranges the first reversed image PR1 in the third region RB3 of the liquid crystal panel 115. The third region RB3 coincides with the first region RB1. The first reversed image PR1 is an image obtained by reversing the first image PC1 in the horizontal direction. In steps S109 and S111, the first executor 152 executes, for example, the processing explained with reference to the fifth image diagram ST15 shown in FIG. 3.

Subsequently, in step S113, the first executor 152 projects the displayable range RB of the liquid crystal panel 115 onto the projectable range RA of the screen SC to thereby project the first reversed image PR1 onto the first region RA1 of the screen SC. In step S113, the first executor 152 executes, for example, the processing explained with reference to the sixth image diagram ST16 shown in FIG. 3. Thereafter, the processing is ended.

When the instruction receiver 151 determines in step S105 that the second instruction CM2 has been received (YES in step S105), in step S115, the second executor 153 reverses the panel coordinate of the liquid crystal panel 115 in the horizontal direction. The second executor 153 reverses the direction of the U axis of the liquid crystal panel 115. That is, the second executor 153 reversers the positive direction of the U axis of the liquid crystal panel 115 from the right direction to the left direction.

Subsequently, in step S117, the second executor 153 displays, in the displayable range RB of the liquid crystal panel 115, the image in the storable range RC of the image buffer memory 143. In steps S115 to S117, the second executor 153 executes, for example, the processing explained with reference to the fourth image diagram ST24 shown in FIG. 4.

Subsequently, in step S119, the second executor 153 projects the displayable range RB of the liquid crystal panel 115 onto the projectable range RA of the screen SC. As a result, the second executor 153 projects, onto the screen SC, the second reversed image PR2 obtained by horizontally reversing the first image PC1 within the projectable range RA. In step S119, the second executor 153 executes, for example, the processing explained with reference to the fifth image diagram ST15 shown in FIG. 4. Thereafter, the processing is ended.

### 6. Third Processing and Fourth Processing of the Controller

Subsequently, an example of the third processing and the fourth processing of the controller 150 is explained with reference to FIG. 6. FIG. 6 is a flowchart showing an example of the third processing and the fourth processing of the controller 150.

As shown in FIG. 6, in step S201, the controller 150 projects the first image PC1 onto the first region RA1. In step S201, the controller 150 executes, for example, the processing explained with reference to the first image diagram ST11 and the second image diagram ST12 shown in FIG. 3.

Subsequently, in step S203, the instruction receiver 151 determines whether the third instruction CM3 has been received from the user.

When the instruction receiver 151 determines that the third instruction CM3 has been received (YES in step S203), the processing proceeds to step S207. The third executor 154 executes the “third processing” in steps S207 to S213. When the instruction receiver 151 determines that the third instruction CM3 has not been received (NO in step S203), the processing proceeds to step S205.

In step S205, the instruction receiver 151 determines whether the fourth instruction CM4 has been received from the user.

When the instruction receiver 151 determines that the fourth instruction CM4 has been received (YES in step S205), the processing proceeds to step S215. The fourth executor 155 executes the “fourth processing” in steps S215 to S219. When the instruction receiver 151 determines that the fourth instruction CM4 has not been received (NO in step S205), the processing returns to step S203.

When the instruction receiver 151 determines in step S203 that the third instruction CM3 has been received (YES in step S203), in step S207, the third executor 154 moves the display position of the first image PC1 in the vertical direction according to the geometric correction in the image buffer memory 143. The third executor 154 moves, according to the geometric correction in the image buffer memory 143, for example, the display position of the first image PC1 to a position symmetrical with respect to a center line that vertically symmetrically divides the image buffer memory 143.

Subsequently, in step S209, the third executor 154 reverses the panel coordinate of the liquid crystal panel 115 in the vertical direction. The third executor 154 reverses the direction of the V axis of the liquid crystal panel 115. That is, the third executor 154 reverses the positive direction of the V axis of the liquid crystal panel 115 from the downward direction to the upward direction.

Subsequently, in step S211, the third executor 154 displays, in the displayable range RB of the liquid crystal panel 115, the image in the storable range RC of the image buffer memory 143. As a result, the third executor 154 arranges the third reversed image in the first region RB1 of the liquid crystal panel 115. The third reversed image is an image obtained by reversing the first image PC1 in the vertical direction.

Subsequently, in step S213, the third executor 154 projects the displayable range RB of the liquid crystal panel 115 onto the projectable range RA of the screen SC to thereby project the third reversed image onto the first region RA1 of the screen SC. Thereafter, the processing is ended.

When the instruction receiver 151 determines in step S205 that the fourth instruction CM4 has been received (YES in step S205), in step S215, the fourth executor 155 reverses the panel coordinate of the liquid crystal panel 115 in the vertical direction. The fourth executor 155 reverses the direction of the V axis of the liquid crystal panel 115. That is, the fourth executor 155 reverses the positive direction of the V axis of the liquid crystal panel 115 from the downward direction to the upward direction.

Subsequently, in step S217, the fourth executor 155 displays, in the displayable range RB of the liquid crystal panel 115, the image in the storable range RC of the image buffer memory 143.

Subsequently, in step S219, the fourth executor 155 projects the displayable range RB of the liquid crystal panel 115 onto the projectable range RA of the screen SC. As a result, the fourth executor 155 projects, onto the screen SC, the fourth reversed image obtained by vertically reversing the first image PC1 within the projectable range RA. Thereafter, the processing is ended.

As explained with reference to FIG. 6, in the initial state, the controller 150 displays the first image PC1 in the first region RA1 of the screen SC. The third executor 154 moves the display position of the first image PC1 in the vertical direction according to the geometric correction in the image buffer memory 143 and reverses the panel coordinate of the liquid crystal panel 115 in the vertical direction. As a result, the third executor 154 can project, onto the first region RA1 of the screen SC, the third reversed image obtained by reversing the first image PC1 in the vertical direction.

The fourth executor 155 reverses the panel coordinate of the liquid crystal panel 115 in the vertical direction. As a result, the fourth executor 155 can project, onto the screen SC, the fourth reversed image obtained by vertically reversing the first image PC1 within the projectable range RA.

In this embodiment, the case in which the controller 150 executes the first processing and the second processing is explained with reference to FIG. 5. The case in which the controller 150 executes the third processing and the fourth processing is explained with reference to FIG. 6. However, not only this, but the controller 150 only has to execute at least the first processing. For example, the controller 150 may execute the first processing to the fourth processing.

### 7. This Embodiment and Action Effects

As explained above with reference to FIGS. 1 to 6, the control method for the projector 100 according to this embodiment includes setting, on the inside of the projectable range RA of the projector 100, the first region RA1 where the first image PC1 is displayed, the first region RA1 being the rectangular region smaller than the projectable range RA and, when receiving the first instruction CM1 to horizontally reverse the first image PC1 within the first region RA1, arranging, in the first region RA1, the first reversed image PR1 obtained by horizontally reversing the first image PC1.

With this configuration, in the control method for the projector 100, when the first instruction CM1 to horizontally reverse the first image PC1 within the first region RA1 is received, the first reversed image PR1 obtained by horizontally reversing the first image PC1 is arranged in the first region RA1. Therefore, it is possible to project the first reversed image PR1 obtained by horizontally reversing the first image PC1 within the first region RA1.

In the control method for the projector 100 according to this embodiment, the setting the first region RA1 includes setting the first region RA1 in the position where the line that horizontally symmetrically divides the projectable range RA and the line that horizontally symmetrically divides the first region RA1 do not coincide, and the arranging the first reversed image PR1 in the first region RA1 includes moving the display position of the first image PC1 in the horizontal direction according to the geometric correction in the image buffer memory 143 and horizontally reversing the panel coordinate of the liquid crystal panel 115.

With this configuration, it is possible to arrange the first reversed image PR1 in the first region RA1 by moving the display position of the first image PC1 in the horizontal direction according to the geometric correction in the image buffer memory 143 and horizontally reversing the panel coordinate of the liquid crystal panel 115. Therefore, it is possible to easily project the first reversed image PR1 obtained by horizontally reversing the first image PC1 within the first region RA1.

The control method for the projector 100 according to this embodiment includes, when receiving the second instruction CM2 to horizontally reverse the first image PC1 within the projectable range RA, arranging the second reversed image PR2 obtained by horizontally reversing the first image PC1 within the projectable range RA.

With this configuration, when the second instruction CM2 to horizontally reverse the first image PC1 within the projectable range RA is received, the second reversed image PR2 obtained by horizontally reversing the first image PC1 within the projectable range RA is arranged. Therefore, it is possible to project the second reversed image PR2 obtained by horizontally reversing the first image PC1 within the projectable range RA.

In the control method for the projector 100 according to this embodiment, the setting the first region RA1 includes setting the first region RA1 in the position where the line that vertically symmetrically divides the projectable range RA and the line that vertically symmetrically divides the first region RA1 do not coincide, and the control method for the projector 100 includes, when receiving the third instruction CM3 to vertically reverse the first image PC1 within the first region RA1, arranging, in the first region RA1, the third reversed image obtained by vertically reversing the first image PC1.

With this configuration, when the third instruction CM3 to vertically reverse the first image PC1 within the first region RA1 is received, the third reversed image obtained by vertically reversing the first image PC1 is arranged in the first region RA1. Therefore, it is possible to project the third reversed image obtained by vertically reversing the first image PC1 within the first region RA1.

In the control method for the projector 100 according to this embodiment, the arranging the third reversed image in the first region RA1 includes moving the display position of the first image PC1 in the vertical direction according to the geometric correction in the image buffer memory 143 and vertically reversing the panel coordinate of the liquid crystal panel 115.

With this configuration, it is possible to arrange the third reversed image in the first region RA1 by moving the display position of the first image PC1 in the vertical direction according to the geometric correction in the image buffer memory 143 and vertically reversing the panel coordinate of the liquid crystal panel 115. Therefore, it is possible to easily project the third reversed image obtained by vertically reversing the first image PC1 within the first region RA1.

The control method for the projector 100 according to this embodiment includes, when receiving the fourth instruction CM4 to vertically reverse the first image PC1 within the projectable range RA, arranging the fourth reversed image obtained by vertically reversing the first image PC1 within the projectable range RA.

With this configuration, when the fourth instruction CM4 to vertically reverse the first image PC1 within the projectable range RA is received, the fourth reversed image obtained by vertically reversing the first image PC1 within the projectable range RA is arranged. Therefore, it is possible to project the fourth reversed image obtained by vertically reversing the first image PC1 within the projectable range RA.

The projector 100 according to this embodiment includes the controller 150, the controller 150 executing setting, on the inside of the projectable range RA of the projector 100, the first region RA1 where the first image PC1 is displayed, the first region RA1 being the rectangular region smaller than the projectable range RA and, when receiving the first instruction CM1 to horizontally reverse the first image PC1 within the first region RA1, arranging, in the first region RA1, the first reversed image PR1 obtained by horizontally reversing the first image PC1.

With this configuration, the projector 100 according to this embodiment achieves the same effects as the effects of the control method for the projector 100 according to this embodiment.

### 8. Other Embodiments

The embodiment explained above is a preferred mode of implementation. However, embodiments of the present disclosure are not limited to the embodiment explained above. Various modified implementations are possible without departing from the gist of the present disclosure.

The functional units shown in FIGS. 1 and 2 indicate functional components. Specific implementation forms of the functional units are not particularly limited. That is, hardware individually corresponding to the functional units does not always need to be implemented. It is naturally possible that one processor executes a program to realize functions of a plurality of functional units. A part of functions realized by software in the embodiment may be realized by hardware or a part of functions realized by hardware in the embodiment may be realized by software. Besides, specific detailed configurations of the other units of the projector 100 can also be optionally changed without departing from the gist of the present disclosure.

The processing units of the flowcharts shown in FIGS. 5 and 6 are divided according to main processing contents in order to facilitate understanding of the processing of the controller 150. The processing units of the flowcharts shown in FIGS. 5 and 6 are not limited by a way of the division and names of the processing units and can also be divided into a larger number of processing units or can also be divided such that one processing unit includes a larger number of kinds of processing according to the processing contents. The processing order of the flowcharts explained above is not limited to the illustrated example.

After the reversed image is displayed in the flowcharts of FIGS. 5 and 6, the flowcharts of FIGS. 5 and 6 may be executed again using the reversed image as the first image.

As the order of executing the flowchart of FIG. 5 and the flowchart of FIG. 6, whichever of the flowcharts may be executed first or the flowcharts may be executed a plurality of times.

The control method for the projector 100 can be realized by causing the processor 150A included in the projector 100 to execute the control program 156 corresponding to the control method for the projector 100. The control program 156 can also be recorded in a recording medium to be readable by a computer. As the recording medium, a magnetic or optical recording medium or a semiconductor memory device can be used.

Specifically, examples of the recording medium include portable recording media such as a flexible disk, a HDD, a CD-ROM (Compact Disk Read Only Memory), a DVD, a Blu-ray (registered trademark) Disc, a magneto-optical disk, a flash memory and a card-type recording medium, and stationary recording media. The recording medium may be a nonvolatile storage device such as a RAM, a ROM, or a HDD that is an internal storage device included in an image processing apparatus.

The control method for the projector 100 can also be realized by causing a server apparatus or the like to store the control program 156 corresponding to the control method for the projector 100 and downloading the control program 156 from the server apparatus to the projector 100.

What is claimed is:

1. A control method for a projector comprising:
setting, on an inside of a projectable range of a projector, a first region where a first image is displayed, the first region being a rectangular region smaller than the projectable range; and
when receiving a first instruction to horizontally reverse the first image within the first region, arranging, in the first region, a first reversed image obtained by horizontally reversing the first image.

2. The control method for the projector according to claim 1, wherein the setting the first region includes setting the first region in a position where a line that horizontally symmetrically divides the projectable range and a line that horizontally symmetrically divides the first region do not overlap.

3. The control method for the projector according to claim 2, wherein the arranging the first reversed image in the first region includes:
moving a display position of the first image in a left or right direction according to geometric correction in an image buffer memory; and
horizontally reversing a panel coordinate of a liquid crystal panel.

4. The control method for the projector according to claim 1, further comprising, when receiving a second instruction to horizontally reverse the first image within the projectable range, arranging a second reversed image obtained by horizontally reversing the first image within the projectable range.

5. The control method for the projector according to claim 1, wherein
the setting the first region includes setting the first region in a position where a line that vertically symmetrically divides the projectable range and a line that vertically symmetrically divides the first region do not overlap, and
the control method further comprises, when receiving a third instruction to vertically reverse the first image within the first region, arranging, in the first region, a third reversed image obtained by vertically reversing the first image.

6. The control method for the projector according to claim 5, wherein the arranging the third reversed image in the first region includes:
moving a display position of the first image in a vertical direction according to geometric correction in an image buffer memory; and
vertically reversing a panel coordinate of a liquid crystal panel.

7. The control method for the projector according to claim 1, further comprising, when receiving a fourth instruction to vertically reverse the first image within the projectable range, arranging a fourth reversed image obtained by vertically reversing the first image within the projectable range.

8. A projector comprising:
at least one processor programmed to execute
setting, on an inside of a projectable range of the projector, a first region where a first image is displayed, the first region being a rectangular region smaller than the projectable range; and
when receiving a first instruction to horizontally reverse the first image within the first region, arranging, in the first region, a first reversed image obtained by horizontally reversing the first image.
